(19) United States
(12) Patent Application Publication
(10) Pub. No.: US 2012/0267484 A1
(43) Pub. Date: Oct. 25, 2012

(54) DEVICE FOR FASTENING HEAT TRANSFER MEDIUM LINES TO A CONTAINER

(75) Inventors: Stefan Wittmer, Edenkoben (DE); Stefan Bregel, Speyer (DE); Hasan Amasheh, Mutterstadt (DE)

(73) Assignee: BASF SE, Ludwigshafen (DE)

(21) Appl. No.: 13/449,912

(22) Filed: Apr. 18, 2012

Related U.S. Application Data
(60) Provisional application No. 61/477,633, filed on Apr. 21, 2011.

(51) Int. Cl. F16L 3/22; B23P 19/04

(52) U.S. Cl. 248/68.1; 29/525.01

(57) ABSTRACT

A fastening device for heat transfer medium lines comprising a strip-shaped carrier element (10) and a plurality of claw-shaped retaining elements (12) which in each case comprise two side parts, one end of which is firmly joined to the upper side of the carrier element (10), it being possible to place a heat transfer medium line (30) between the in each case two side parts of a retaining element (12), wherein the side parts of the retaining elements (12) comprise a collar (14) at their end remote from the carrier element (10) and, with regard to their transverse orientation, are arranged substantially perpendicularly to the longitudinal direction of the carrier element (10).

The present application incorporates provisional U.S. application 61/477,633 filed Apr. 21, 2011 by reference.

The present invention relates to a fastening device for heat transfer medium lines comprising a strip-shaped carrier element and a plurality of claw-shaped retaining elements which in each case comprise two side parts, one end of which is firmly joined to the upper side of the carrier element, it being possible to place a heat transfer medium line between the in each case two side parts of a retaining element. The invention furthermore relates to the use of such a fastening device for fastening heat transfer medium lines as heat tracing for containers.

In process engineering and other branches of industry, it is conventional to provide piping, containers or parts of apparatuses such as reactors and columns with heat tracing. Such heat tracing may serve various purposes, for example to prevent piping from freezing or to compensate heat losses from the container's contents through the container wall. Various approaches and process technology implementations are known for putting heat tracing into practice. One approach involves applying heating cables or heating mats onto pipes or containers and heating by means of electrical energy. This approach does, however, have the disadvantage that it is associated with elevated costs and can only be used for heating. Cooling cannot be brought about in this manner.

Another approach provides using pipes or hoses as heat transfer medium lines through which a liquid or gaseous heat transfer medium is passed, the term “gaseous” here and hereinafter also denoting “in vapor form”. Such systems overcome the above-stated disadvantages in that, depending on the heat transfer medium, they may be used for heating or for cooling. The heat transfer medium lines may be mounted directly on the piping or containers to be temperature-controlled. Half-pipe or full-pipe coils which are tightly welded or clamped onto the container wall are, for example, known. This form of heat tracing does indeed have the advantage of efficient heat transfer, as the heat transfer medium is in direct contact with the container wall. However, one drawback is that, in the event of even slight expansion in the container wall, stress cracking may occur in the half-pipe coils, resulting in leaks. Moreover, the maintenance and repair of such systems is complex and costly.

In another form of heat tracing, the heat transfer medium lines are mounted at a short distance away from the piping or containers to be temperature-controlled. Such a system is known, for example, from patent application EP 1 063 459 A1. The document describes a device for fastening heat transfer medium lines which provides a clamp into which the heat transfer medium line can be snap-fitted, and which is fastened to the pipe or container to be temperature-controlled by means of a strap. This system is well suited to piping, since a heat transfer medium line may simply and rapidly be fastened to the pipe with the assistance of the strap. However, this type of fastening is less suitable for equipping containers, in particular containers having a diameter from for instance 0.5 m. In such a case, at least two people are required for fitting, since one person alone cannot arrange the strap in the desired position on the container. Moreover, fastening the numerous clamps which are required to equip a container to the container is troublesome and complex using straps.

The object arose of providing a device which allows heat transfer medium lines to be fastened simply and efficiently to a container. The device should additionally be robust and inexpensive to produce.

The object is achieved according to the invention by a fastening device according to claim 1. Advantageous developments of the invention are stated in dependent claims 2 to 14. The present invention also provides the use of a fastening device according to claims 15 and 16.

The fastening device according to the invention is particularly suitable for fastening heat transfer medium lines to a container, in particular as heat tracing for the container. It is particularly suitable for installing heat transfer medium lines as heat tracing for containers with a large diameter, in particular for reactors or columns in process engineering installations. A large diameter is taken to mean a diameter which a person cannot fully encompass with both arms.

The fastening device is particularly suitable for heat transfer medium lines in tube or hose form. One use according to the invention of the fastening device relates to corrugated hoses as heat transfer medium lines through which a liquid or gaseous heat transfer medium is passed. It is particularly suitable to use hot water or steam as the heat transfer medium, since such media may usually be supplied inexpensively in process engineering installations. Corrugated hoses are commercially available from various suppliers and are known to a person skilled in the art.

The fastening device according to the invention for heat transfer medium lines comprises a strip-shaped carrier element and a plurality of claw-shaped retaining elements. “Strip-shaped” is here taken to mean that the extent of the carrier element in the longitudinal direction, hereinafter also denoted “length”, is distinctly greater than its extent in the transverse direction, which is defined as being perpendicular to the longitudinal direction and is hereinafter also denoted “width”. The width is in turn distinctly greater than the extent which is perpendicular to both the longitudinal and the transverse direction and is hereinafter denoted “thickness” or “material thickness” of the carrier element.

In a preferred embodiment, the material thickness of the carrier element amounts to from 4 mm to 12 mm, particularly preferably from 5 mm to 7 mm. The width of the carrier element preferably amounts to from 1.5 cm to 4 cm, particularly preferably from 2 cm to 3 cm. Depending on the manufacturing technology, the carrier element may be produced as a continuous product or in a predetermined length. If the carrier element is produced in individual pieces, lengths of 80 cm to 120 cm are preferred.

Each retaining element comprises two side parts, one end of which is in each case firmly joined to the upper side of the carrier element. The two side parts extend away outwards from the upper side of the carrier element in such a manner that they form a claw and a heat transfer medium line may be placed between the two side parts. In one advantageous development, the two side parts are arranged such that their respective inner surfaces are substantially parallel to one another. According to the invention, the side parts are arranged, with regard to their transverse extent, substantially perpendicular to the longitudinal direction of the carrier element, deviations of plus/minus 5 angular degrees still being considered to be “substantially perpendicular”. The side parts, with regard to the extent thereof away from the carrier element, are furthermore also preferably arranged perpendicularly within the bounds of manufacturing accuracy. The wall thickness of the side parts preferably amounts to from 1.5 mm to 4 mm, particularly preferably from 2 mm to 3 mm.

The side parts of the retaining elements have a collar at their end remote from the carrier element. In a preferred embodiment, the collars are located at the ends of the mutually facing inner sides of the respective side parts of a retaining element and are dimensioned such that the heat transfer medium line may be snap-fitted from outside through the gap between the two respective collars towards the carrier element into the interior of the retaining element. After snap-fitting, the collars prevent the heat transfer medium line from slipping out from the interior or make this more difficult.

In a further preferred embodiment, at the ends of the side parts, the collars extend back outwards from their outer side. In this embodiment, the fastening device furthermore comprises securing caps with recesses, the collars and recesses being shaped complementarily to one another, such that the securing caps may be placed over the collars. In order to fasten a heat transfer medium line, the latter is in this case initially laid in the gap between the side parts of a retaining element and then the retaining element is closed at its open end by the securing cap, such that, once a securing cap has been set in place over the collars of a retaining element, the heat transfer medium line is fixed in the retaining element in question. The collars and recesses are preferably adapted to one another in such a manner that, once a securing cap has been set in place over the side parts of a retaining element, a tight fit is obtained, such that the securing cap cannot slip off the retaining element.

The carrier element preferably comprises notches on its underside between adjacent retaining elements. Particularly preferably, a notch is located in each case between two adjacent retaining elements. The notches advantageously extend over the entire width of the carrier element. Observed in longitudinal section, the notches may have any desired shape; they are preferably v-shaped or u-shaped in longitudinal section. The notches increase the flexibility of the carrier element in the longitudinal direction, such that the carrier element may for example readily be laid against and fastened to curved surfaces of a container. In addition, the carrier elements may readily be shortened to the desired length by being divided at the notches with a tool, for example with a knife. The minimum material thickness of the carrier element between its upper side and the lowest point of the notch particularly preferably amounts to from 1 mm to 2 mm. It has been found that a balanced relationship between the flexibility of the carrier element and its stability is obtained within this range of values.

In a preferred development, the carrier element comprises lateral protrusions, the extent of which perpendicular to the longitudinal edge of the carrier element amounts to from 1 cm to 4 cm, in particular from 2 cm to 3 cm, and the extent of which in the direction of the longitudinal edge of the carrier element amounts to from 1 cm to 4 cm, in particular from 2 cm to 3 cm. The protrusions may be present exclusively on one side of the carrier element or on both sides. If protrusions are provided on both sides, they may be located, observed in the longitudinal direction, opposite one another in each case at the same level or be located regularly or irregularly alternately on opposite sides. The protrusions are not taken into account in the above definition of the width of the carrier element. These protrusions may advantageously be used to fasten the carrier element to a container, for example by tensioning a strap parallel to the longitudinal edge of the carrier element over the protrusions. Viewed in the longitudinal direction of the carrier element, the protrusions are particularly preferably located at the level of the retaining elements.

The distance between opposing inner surfaces of the side parts of a retaining element preferably corresponds to from 95% to 105%, in particular from to 98% to 100% of the external diameter of the heat transfer medium line which is to be fastened therein. In the embodiment with outwardly directed collars and securing cap, the height of the retaining elements is preferably selected that, once the securing caps have been set in place, the distance between the upper side of the carrier element and the inner side of the securing cap corresponds to from 95% to 105%, in particular from 98% to 100% of the external diameter of the heat transfer medium line. It has been found that such dimensioning of the internal space between the side parts and optionally the carrier element and the securing cap promotes a firm fit of the heat transfer medium line in the retaining element.

In order to accommodate tubular heat transfer medium lines such as corrugated hoses, it has proved advantageous to select the distance between the inner surfaces of the mutually facing side parts of two adjacent retaining elements in accordance with twice the minimum bending radius of the tubular heat transfer medium line to be accommodated. This facilitates fitting of a tubular heat transfer medium line where the lines are repeatedly bent by 180°. This measure prevents damage to the heat transfer medium line by kinking. The minimum bending radius depends on the material, design and size of the heat transfer medium line to be used.

In one preferred development of the fastening device, the carrier element, the retaining elements and optionally present protrusions on the carrier element are based on the same material. They are particularly preferably integrally joined to one another. Selection of the material depends inter alia on conditions of use, the temperature of the surface against which the underside of the carrier element rests being of particular significance.

The carrier element, the retaining elements and optionally present protrusions are manufactured from a polyamide material as described in detail below. In one embodiment of the fastening device with securing caps, the latter are preferably manufactured from a thermoplastic plastics material.

Any melt-processable polymer may in principle be used as the thermoplastic plastics material for the components according to the invention. In particular, a plastics material or a plurality of plastics materials selected from polyethylene, polypropylene, polyvinyl chloride, polystyrene, impact-modified polystyrene (HIPS), acrylonitrile-butadiene-styrene copolymer (ABS), acrylonitrile-styrene-acrylate copolymer (ASA), methacrylate-acrylonitrile-butadiene-styrene copolymer (MABS), styrene-butadiene block copolymer, polyamide, polyethylene terephthalate (PET), polyethylene terephthalate glycol (PETG), polybutylene terephthalate (PBT), polyoxymethylene (POM), polycarbonate (PC), polymethyl methacrylate (PMMA), poly(ether)sulfones, melt-processable polyurethane (TPU) and polyphenylene oxide (PPO) is/are suitable. Particularly preferred plastics materials are polyamides, polysulfones, polyethersulfones and polyphenylenesulfones.

The stated plastics may be used in pure form or as a mixture with auxiliary substances conventional in plastics. In a preferred embodiment, plastics provided with fibrous or particulate fillers are used. Particularly suitable fillers are glass fibers, glass beads, mineral fillers or “nanoparticles”. Glass fiber reinforced polyamides are very particularly preferred.

Polysulfones (hereinafter denoted “PSU”) should be taken to mean any polymers having repeat units linked by sulfone groups of formula (I):

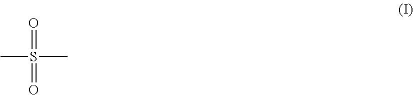

Suitable PSUs are for example polymers with repeat units of formula (II), R₁ meaning alkyl or aryl:

—R₁—SO₂— (II).

Preferred PSUs are polymers with repeat units of formula (III), R₂, R₃, R₄ and R₅ mutually independently meaning aryl, in particular phenyl:

—R₂—C(CH₃)₂—R₃—O—R₄—SO₂—R₅— (III).

PSUs which are furthermore preferred are polymers with repeat units of formula (IV), R₆ and R₇ mutually independently meaning aryl, in particular phenyl:

—R₆—SO₂—R₇—O— (IV).

Such PSUs with repeat units of formula (IV) are often also known as polyethersulfones.

PSUs which are furthermore preferred are polymers with repeat units of formula (V), R₈, R₉, R₁₀ and R₁₁ mutually independently meaning aryl, in particular phenyl:

—R₈—O—R₉—SO₂—R₁₀—R₁₁—SO₂— (V).

Such PSUs with repeat units of formula (V) are often also known as polyphenylenesulfones.

The stated PSUs and the production processes thereof are known to a person skilled in the art, described in the literature and are commercially available, for example, under the trade name Ultrason® of BASF SE.

The term polyamide is taken to mean not only all known polyamides but also plastics materials which are based on mixtures of polyamide with further components. Polyamides having an aliphatic, partially crystalline or partially aromatic and amorphous structure of any kind and the blends thereof, including polyetheramides such as polyether block amides may, for example, be considered. Suitable polyamides generally have an intrinsic viscosity of 90 to 350, preferably 110 to 240 ml/g, determined in a 0.5 wt. % solution in 96 wt. % sulfuric acid at 25° C. to ISO 307.

Semicrystalline or amorphous resins with a molecular weight (weight average) of at least 5,000, as are for example described in U.S. Pat. Nos. 2,071,250, 2,071,251, 2,130,523, 2,130,948, 2,241,322, 2,312,966, 2,512,606 and 3,393,210, are preferred. Examples are polyamides which are derived from lactams with 7 to 13 ring members, such as polycaprolactam, polycapryllactam and polylaurolactam, and polyamides which are obtained by reacting dicarboxylic acids with diamines.

Alkanedicarboxylic acids with 6 to 12, in particular 6 to 10 carbon atoms, and aromatic dicarboxylic acids may be used as dicarboxylic acids. Mention is made here only of adipic acid, azelaic acid, sebacic acid, dodecanedioic acid and terephthalic and/or isophthalic acid as acids.

Suitable diamines are in particular alkanediamines with 6 to 12, in particular 6 to 8 carbon atoms and m-xylylenediamine (e.g. Ultramid® X17 from BASF SE, a 1:1 molar ratio of MXDA with adipic acid), di-(4-aminophenyl)methane, di-(4-aminocyclohexyl)methane, 2,2-di-(4-aminophenyl)propane, 2,2-di-(4-aminocyclohexyl)propane or 1,5-diamino-2-methylpentane.

Preferred polyamides are polyhexamethylene adipamide, polyhexamethylene sebacamide and polycaprolactam as well as copolyamide 6/66, in particular with a proportion of 5 to 95 wt. % of caprolactam units (e.g. Ultramid® C31 from BASF SE).

Polyamides which are furthermore suitable are obtainable from ω-aminoalkylnitriles such as for example aminocapronitrile (PA 6) and adipodinitrile with hexamethylenediamine (PA 66) by “direct polymerization” in the presence of water, as for example described in DE 103 13 681 A1, EP 1 198 491 A1 and EP 0 922 065. Moreover, polyamides which are obtained, for example, by condensation of 1,4-diaminobutane with adipic acid at elevated temperature (polyamide 4,6) may also be mentioned. Production methods for polyamides of this structure are described, for example in EP 0 038 094 A2, EP 0 038 582 A2 and EP 0 039 524 A1.

Polyamides which are furthermore suitable are those obtainable by copolymerization of two or more of the above-stated monomers or mixtures of a plurality of polyamides, the mixing ratio being as desired. Mixtures of polyamide 66 with other polyamides, in particular copolyamide 6/66, are particularly preferred.

Those partially aromatic copolyamides, such as PA 6/6T and PA 66/6T, having a triamine content of less than 0.5, preferably of less than 0.3 wt. % (see EP 0 299 444 A2) have furthermore proved to be particularly advantageous. Further polyamides resistant to elevated temperatures are known from EP 1 994 075 A0 (PA 6T/6I/MXD6). The preferred partially aromatic copolyamides with a low triamine content may be produced by the methods described in EP 0 129 195 A2 and EP 0 129 196 A2.

Particularly preferred polyamide materials are those containing
A) 10 to 99.999 wt. % of a polyamide,
B) 0.001 to 20 wt. % of iron powder with a particle size of at most 10 μm (d₅₀ value), which is obtainable by thermal decomposition of iron pentacarbonyl, and
C) 0 to 70 wt. % of further additives,
   the sum of the weight percentages of components A) to C) amounting to 100%. According to the invention, at least the carrier element and the retaining elements are manufactured from such a polyamide material. These polyamide materials exhibit improved heat aging resistance together with good mechanical and surface characteristics, even after extended thermal aging. They are particularly advantageous for use on container surfaces which, in continuous service, exhibit temperatures of more than 180° C. Moreover, these polyamide materials are also suitable for sustained operation at low temperatures down to about minus 30° C., at which other materials eventually become brittle.

As component A), these polyamide materials contain 10 to 99.999, preferably 20 to 98 and in particular 25 to 94 wt. % of at least one polyamide, as described above.

As component B), the polyamide materials contain 0.001 to 20, preferably 0.05 to 10 and in particular 0.1 to 5 wt. % of iron powder which is obtainable by thermal decomposition of iron pentacarbonyl, preferably at temperatures of 150° C. to 350° C. The particles obtainable in this manner have a preferably spherical shape, i.e. they are spherical or virtually spherical (also known as spherulitic). The iron powder preferably has a particle size of at most 10 μm (d50 value).

A preferred iron powder has a particle size distribution as described below, the particle size distribution being determined by means of laser diffraction in a highly dilute aqueous suspension (e.g. using a Beckmann LS13320 instrument). The particle size (and distribution) described below may optionally be established by grinding and/or screening.
dₓₓ here means that XX % of the total volume of the particles is less than the value.
d₅₀ values: max. 10 μm, preferably 1.6 to 8, in particular 2.9 to 7.5 μm, very particularly 3.4 to 5.2 μm
d₁₀ values: preferably 1 to 5 μm, in particular 1 to 3 and very particularly 1.4 to 2.7 μm
d₉₀ values: preferably 3 to 35 μm, in particular 3 to 12 and very particularly 6.4 to 9.2 μm.

Component B) preferably has an iron content of 97 to 99.8 g/100 g, preferably of 97.5 to 99.6 g/100 g. The content of further metals preferably amounts to less than 1000 ppm, in particular to less than 100 ppm and very particularly to less than 10 ppm. Fe content is conventionally determined by infrared spectroscopy.

The C content preferably amounts to 0.01 to 1.2, preferably to 0.05 to 1.1 g/100 g and in particular to 0.4 to 1.1 g/100 g. In the preferred iron powders, this C content corresponds to those which are not reduced with hydrogen subsequent to thermal decomposition. The C content is conventionally determined on the basis of ASTM E1019 by combusting the sample quantity in a stream of oxygen followed by IR detection of the resultant gaseous CO₂ (by means of Leco CS230 or CS-mat 6250 from Juwe).

The nitrogen content preferably amounts to at most 1.5 g/100 g, preferably from 0.01 to 1.2 g/100 g.

The oxygen content preferably amounts to at most 1.3 g/100 g, preferably 0.3 to 0.65 g/100 g. N and O are determined by heating the sample to approx. 2100° C. in a graphite furnace. The oxygen obtained in the sample is converted into CO and measured using an IR detector. The N released from the nitrogenous compounds under the reaction conditions is discharged with the carrier gas and detected and recorded by TCD (Thermal Conductivity Detector) (both methods on the basis of ASTM E1019).

Tap density preferably amounts to 2.5 to 5 g/cm³, in particular 2.7 to 4.4 g/cm³. This is generally taken to mean the density found when the powder is for example placed in the container and shaken in order to achieve compaction. Iron powders which are furthermore preferred may be surface-coated with iron phosphate, iron phosphite or SiO₂. The BET surface area to DIN ISO 9277 preferably amounts to from 0.1 to 10 m²/g, in particular 0.1 to 5 m²/g, preferably 0.2 to 1 m²/g and in particular 0.4 to 1 m²/g.

In order to achieve particularly good distribution of the iron particles, a batch comprising a polymer may be used. Polymers such as polyolefins, polyesters or polyamides are suitable for this purpose, the batch polymer preferably being identical to component A). The proportion by mass of iron in the polymer generally amounts to 15 to 80, preferably 20 to 40 mass percent.

As component C), the preferred polyamide materials may contain up to 70, preferably up to 50 wt. % of further additives.

Fibrous or particulate fillers C1) which may be mentioned are carbon fibers, glass fibers, glass beads, amorphous silica, calcium silicate, calcium metasilicate, magnesium carbonate, kaolin, chalk, powdered quartz, mica, barium sulfate and feldspar, which are used in quantities of 1 to 50 wt. %, in particular of 5 to 40, preferably 10 to 40 wt. %. Preferred fibrous fillers which may be mentioned are carbon fibers, aramid fibers and potassium titanate fibers, with glass fibers as E-glass being particularly preferred. These may be used as rovings or chopped strand in conventional commercial forms. To enhance compatibility with the thermoplastics, the fibrous fillers may be surface pretreated with a silane compound. Preferred silane compounds are aminopropyltrimethoxysilane, aminobutyltrimethoxysilane, aminopropyltriethoxysilane, aminobutyltriethoxysilane and the corresponding silanes which contain a glycidyl group as substituent X. The silane compounds are generally used in quantities of 0.01 to 2, preferably of 0.025 to 1.0 and in particular of 0.05 to 0.5 wt. % (relative to C) for surface coating.

Acicular mineral fillers are also suitable. Acicular mineral fillers are taken to mean mineral fillers with a distinctly needle-shaped nature. Acicular wollastonite may be mentioned as an example. The mineral preferably has an L/D (length/diameter) ratio of 8:1 to 35:1, preferably of 8:1 to 11:1. The mineral filler may optionally be pretreated with the above-stated silane compounds; pretreatment is, however, not absolutely necessary.

Further fillers which may be mentioned are kaolin, calcined kaolin, wollastonite, talc and chalk and additionally lamellar or acicular nanofillers preferably in quantities between 0.1 and 10%. Boehmite, bentonite, montmorillonite, vermiculite, hectorite and laponite are preferably used for this purpose. In order to obtain good compatibility of the lamellar nanofillers with the organic binder, the lamellar nanofillers are organically modified according to the prior art. The addition of lamellar or acicular nanofillers to the nanocomposites according to the invention leads to a further increase in mechanical strength.

As component C2), the polyamide materials may contain 0.05 to 3, preferably 0.1 to 1.5 and in particular 0.1 to 1 wt. % of a lubricant. Al, alkali metal, alkaline earth metal salts or esters or amides of fatty acids with 10 to 44 C atoms, preferably with 12 to 44 C atoms, are preferred. Mixtures of various salts may also be used, the mixing ratio being as desired. Mixtures of various esters or amides or esters with amides may also be used in combination, the mixing ratio being as desired.

As component C3), the polyamide materials may contain 0.05 to 3, preferably 0.1 to 1.5 and in particular 0.1 to 1 wt. % of a Cu stabilizer, preferably a Cu(I) halide, in particular in a mixture with an alkali metal halide, preferably KI, in particular in the ratio 1:4, or a sterically hindered phenol or mixtures thereof. Salts of monovalent copper which may preferably be considered are copper(I) acetate, copper(I) chloride, bromide and iodide. These are present in quantities of 5 to 500 ppm of copper, preferably of 10 to 250 ppm, relative to polyamide.

Suitable sterically hindered phenols C3) are in principle any compounds with a phenolic structure which bear at least one sterically demanding group on the phenolic ring.

The antioxidants C), which may be used individually or as mixtures, are present in a quantity of 0.05 up to 3 wt. %, preferably of 0.1 to 1.5 wt. %, in particular of 0.1 to 1 wt. %, relative to the total weight of the polyamide materials A) to C).

As component C4), the polyamide materials may contain 0.05 to 5, preferably 0.1 to 2 and in particular 0.25 to 1.5 wt. % of a nigrosine. Nigrosines are generally taken to mean a group of black or gray phenazine dyes (azine dyes), which are related to the indulines, in various presentations (water-soluble, fat-soluble, spirit-soluble) which are used in wool dyeing and printing, in dyeing silk black, for dyeing leather, shoe polishes, varnishes, plastics, stoving enamels, inks and the like, and as microscopy stains. Nigrosines are obtained industrially by heating nitrobenzene, aniline and hydrochloric aniline with metallic iron and FeCl₃ (name derived from the Latin niger=black). Component C4) may be used as a free base or also as a salt (e.g. hydrochloride).

Further conventional additives C) are, for example, quantities of up to 25, preferably of up to 20 wt. %, of rubber-elastic polymers (often also denoted impact-modifiers, elastomers or rubbers). These very generally comprise copolymers which are preferably synthesized from at least two of the following monomers: ethylene, propylene, butadiene, isobutene, isoprene, chloroprene, vinyl acetate, styrene, acrylonitrile and acrylic or methacrylic acid esters with 1 to 18 C atoms in the alcohol component. Such polymers are described, for example, in Houben-Weyl, Methoden der organischen Chemie, vol. 14/1 (Georg-Thieme-Verlag, Stuttgart, 1961), pages 392 to 406 and in the monograph by C. B. Bucknall, “Toughened Plastics” (Applied Science Publishers, London, 1977).

Examples of preferred emulsion polymers are n-butyl acrylate/(meth)acrylic acid copolymers, n-butyl acrylate/glycidyl acrylate or n-butyl acrylate/glycidyl methacrylate copolymers, graft polymers with an inner core of n-butyl acrylate or based on butadiene and an outer shell of the above-stated copolymers and copolymers of ethylene with comonomers which provide reactive groups. Methods for producing such elastomers are known.

As component C), the polyamide materials may contain conventional processing auxiliaries such as stabilizers, oxidation inhibitors, agents against thermal decomposition and decomposition by ultraviolet light, slip and mold release agents, colorants such as dyes and pigments, nucleating agents, plasticizers etc.

The preferred polyamide materials may be produced in accordance with per se known methods in which the starting components are mixed in conventional mixing devices such as screw extruders, Brabender mills or Banbury mills and then extruded. After extrusion, the extrudate may be cooled and comminuted. Individual components may also be premixed and then the remaining starting materials may be added individually and/or likewise mixed. Mixing temperatures are generally from 230 to 320° C.

According to a further preferred mode of operation, components B) and optionally C) may be mixed, formulated and granulated with a prepolymer. The resultant granules are then continuously or discontinuously condensed to the desired viscosity in the solid phase under inert gas at a temperature below the melting point of component A).

In those cases in which the fastening device according to the invention and optionally the securing caps are manufactured from a thermoplastic plastics material as described above, they may be produced simply and inexpensively, for example by injection molding. A suitable thermoplastic plastics material may be selected for producing the fastening devices and/or the securing caps depending on conditions of use, in particular with regard to the anticipated thermal loading. For relatively high temperatures of the container wall or of the wall of the heat transfer medium line, for example of above 180° C., the above-described polyamide materials with improved heat aging resistance are particularly suitable. These polyamide materials are likewise suitable for use at low temperatures of about minus 30° C.

A fastening element may advantageously be applied to a container using straps which may be guided transversely over the carrier element or parallel to the longitudinal orientation of the carrier element over the above-described protrusions. In a further development of the invention, the carrier element comprises fastening means on its underside which permit the fastening device to be fastened to a container even without auxiliary means such as straps. In a preferred embodiment, the fastening means comprise permanent magnets which are integrated into the underside of the carrier element. In a further preferred development, the fastening means comprises an adhesive coating which is applied onto the underside of the carrier element. A particularly preferred adhesive coating is one which is based on components, as are known from conventional pressure-sensitive adhesives, which may be used for temperatures of approx. 250° C. to approx. 350° C.

The fastening device according to the invention offers a plurality of advantages. In comparison with heat transfer medium lines firmly attached to a container, as are known from the prior art, the fastening device is distinctly less expensive and is simpler to install. The proposed design does not entail the risk of stress cracking. In comparison with known individual elements such as the above-described clamps, the device according to the invention offers the advantage of more rapid and simpler fitting of heat transfer medium lines on a container. Once the fastening elements are mounted on a container, the heat transfer medium lines may straightforwardly be fitted by one person in a short time. Repairs or modifications of already installed heat transfer medium lines may also be carried out more rapidly and inexpensively with the fastening devices according to the invention.

The drawings below explain the invention in further detail, the drawings being intended as schematic diagrams. They do not restrict the invention, for example with regard to specific dimensions or variant configurations. In the drawings:

FIG. 1: shows a longitudinal section through an embodiment of the fastening device according to the invention with three examples of shapes of collars and recesses for the securing caps

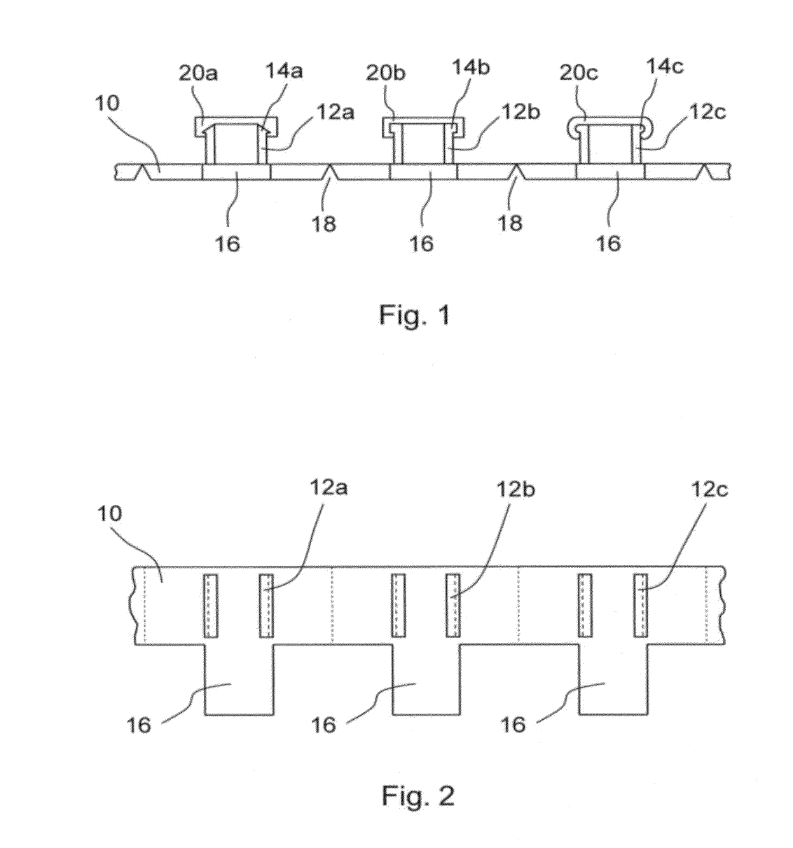

FIG. 2: shows a plan view of the fastening device according to FIG. 1 (securing caps not shown)

FIG. 3: shows a plan view according to FIG. 2 with inserted heat transfer medium line

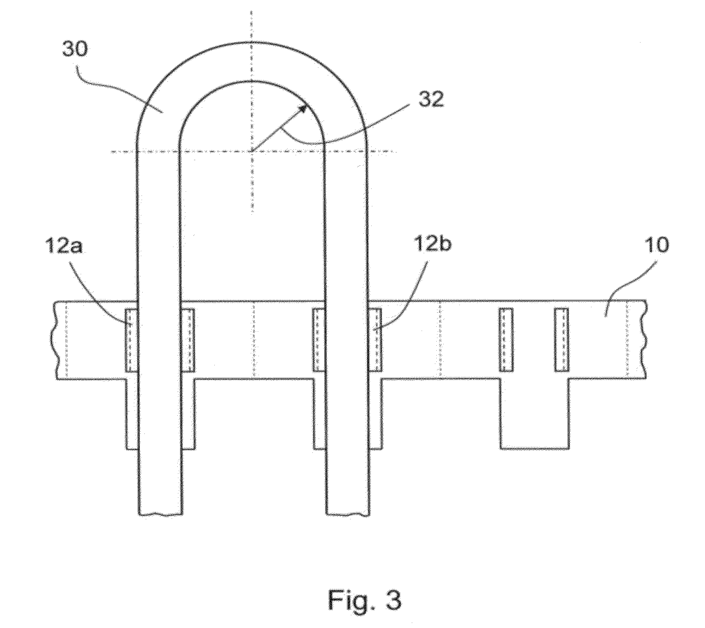

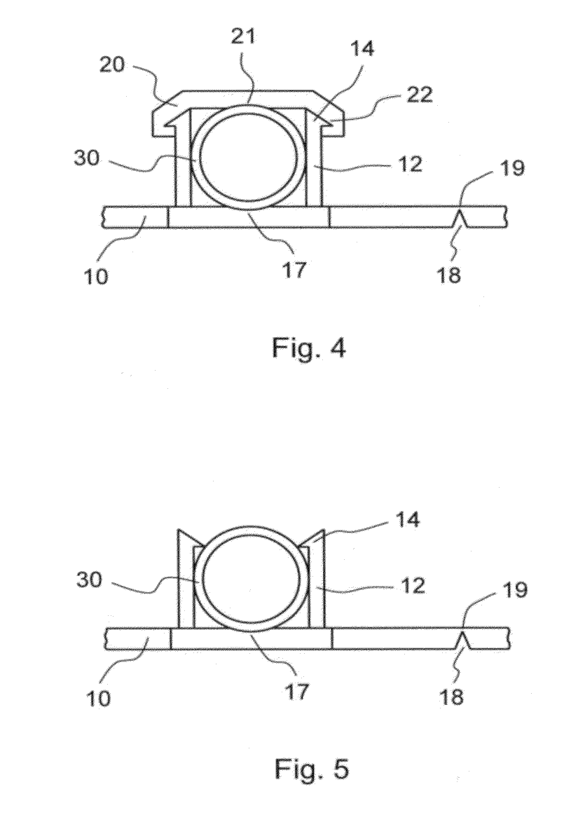

FIG. 4: shows a longitudinal section through a further embodiment of the fastening device according to the invention with securing cap

FIG. 5: shows a longitudinal section through an embodiment of the fastening device according to the invention with inwardly directed collars

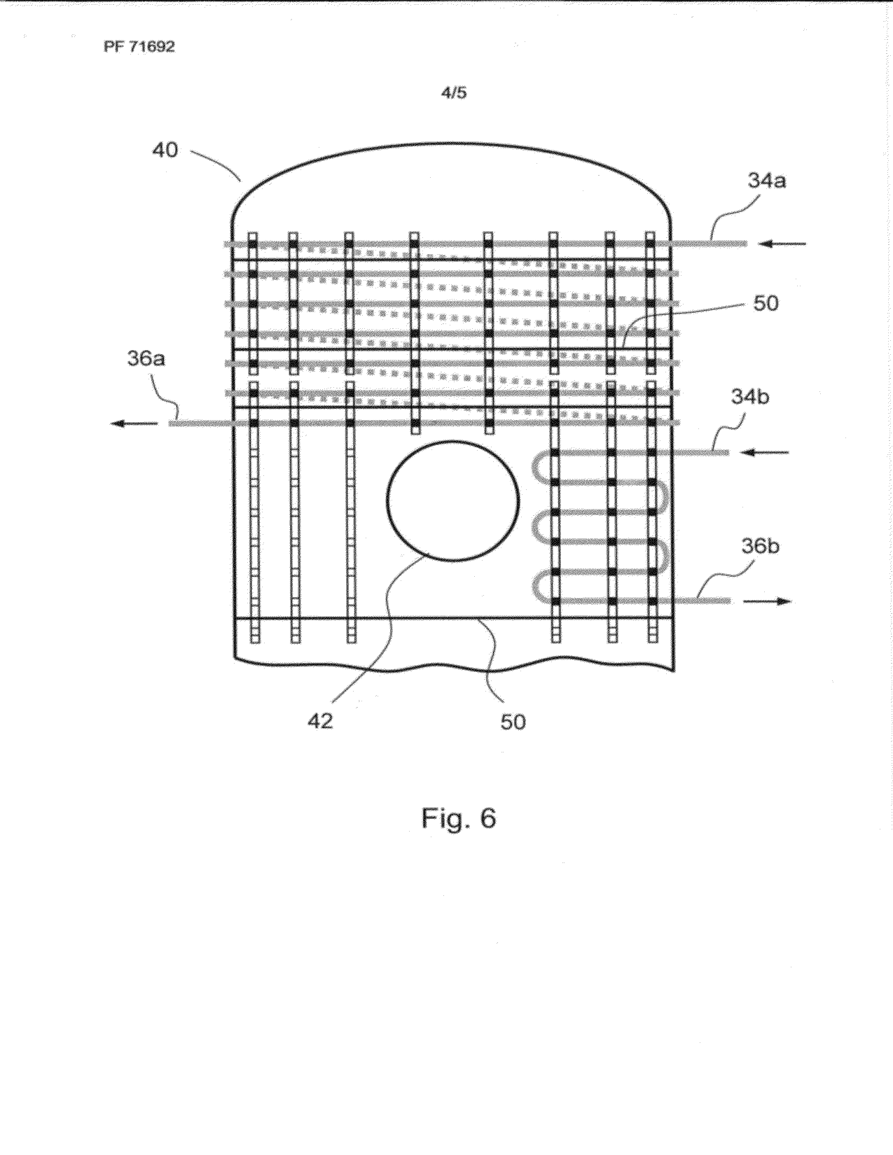

FIG. 6: shows a partial view of an upright container with fastening devices according to the invention and heat transfer medium lines

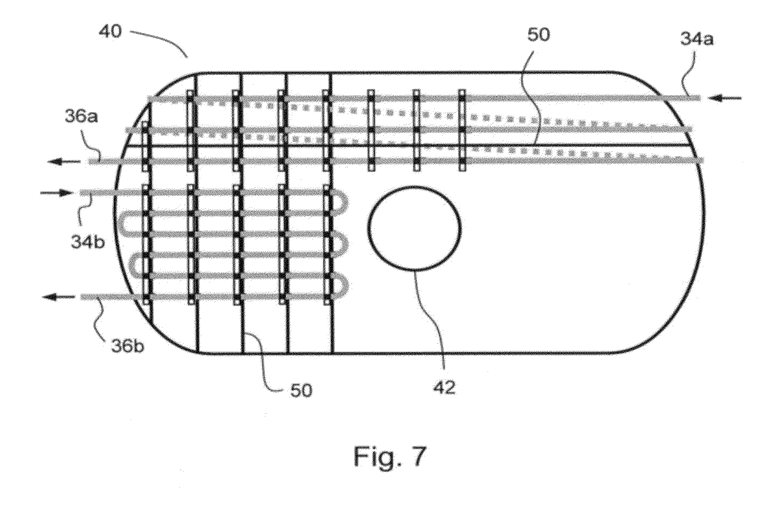

FIG. 7: shows a view of a horizontal container with fastening devices according to the invention and heat transfer medium lines

FIG. 1 shows a longitudinal section through an embodiment of the fastening device according to the invention, with three retaining elements 12a, 12b, 12c with different shapes of collars 14a, 14b, 14c and corresponding recesses in the securing caps 20a, 20b, 20c being shown by way of example. The retaining elements comprise in each case two side parts which are in each case joined at one end with the upper side of the carrier element 10. The carrier element 10 comprises on its underside, in each case between two retaining elements, a notch 18 which in the example shown is of v-shaped construction. The carrier element 10 furthermore in each case comprises, at the level of the retaining elements 12a, 12b, 12c, protrusions 16 which in FIG. 1 project perpendicularly out of the plane of the drawing.

The ends of the side parts remote from the carrier element 10 in each case comprise a collar 14a, 14b, 14c, which extends outwards from the outer side of the side part. The invention encompasses various shapes of collar. The collar need merely be suitable for accommodating a securing cap 20a, 20b, 20c with a corresponding recess in such a manner that, after it has been pushed on, it is secured from slipping out, preferably by a form-fit. FIG. 1 shows three examples of shapes of collar and recess. In the embodiment on the left-hand side, the collar 14a is triangular in shape in longitudinal section. From the inner side of the side part, the collar drops away outwardly, its lowest point, viewed in the longitudinal direction, also being the point which projects the furthest beyond the outer surface of the side part. A shape which is similar to the triangle is the trapezium, in which the oblique flank of the collar does not begin at the inner side of the side part, but instead at the upper end between the inner and the outer side. This example variant is not shown in FIG. 1.

In the embodiment shown in the middle in FIG. 1, the collar 14b and the corresponding recess in the securing cap 20b are rectangular in shape in longitudinal section. The collar 14c and the recess in the securing cap 14c of the embodiment shown on the right are rounded in shape, for example in the form of a semi-circle or semi-ellipse. The shapes should be regarded as examples. It goes without saying that the invention also encompasses other shapes of collars 14 and recesses, providing that, once it has been pushed onto the collars, the securing cap is secured from slipping out. The same applies to the external shape of the securing cap, which is rectangular in longitudinal section in variants 20a and 20b, whereas it is likewise round in variant 20c. Embodiments with rounded shapes offer the advantage that jamming is largely avoided when the securing cap is pushed onto the collars.

FIG. 2 shows a plan view of the fastening device according to FIG. 1, the securing caps being omitted from the diagram. Viewed in the transverse direction of the carrier element 10, the retaining elements 12a, 12b, 12c are arranged centrally. The dashed line in the side parts indicates how far the collar extends beyond the outer side of the respective side part. The dashed lines in the carrier element 10 indicate the course of the notches 18 located on the underside. This diagram clearly shows the protrusions 16, which in the example shown extend perpendicularly outwards from the outer edge of the carrier element 10 at the level of the retaining elements 12a, 12b, 12c. It goes without saying that the invention also encompasses other shapes of protrusions 16 in plan view. For instance, the protrusions 16 may for example also be trapezoidal in shape, the base on the carrier element being wider than the outlying end of the protrusion.

FIG. 3 corresponds to a plan view of the fastening device according to FIG. 2 with inserted heat transfer medium line 30. The securing caps are omitted from the diagram for clarity's sake. In preferred developments of the fastening device according to the invention, the distance between the inner sides of two adjacent retaining elements 12a and 12b corresponds to twice the minimum bending radius 32 of the inserted heat transfer medium line 30. This dimension is dependent on the heat transfer medium line used. The following table states the nominal diameter, the external diameter of the corrugated hose and the minimum bending radius for two commercially obtainable corrugated hose systems from different manufacturers.

| | Manufacturer A | | Manufacturer B | |
|---|---|---|---|---|
| | External | Minimum | | Minimum |
| Nominal | diameter | bending radius | External | bending radius |
| diameter | (mm) | (mm) | diameter (mm) | (mm) |
| DN 15 | 22.0 | 30 | 21.4 | 25 |
| DN 20 | 25.7 | 35 | 26.5 | 30 |
| DN 25 | 31.5 | 40 | 31.7 | 35 |

FIG. 4 shows a longitudinal section through a further embodiment of the fastening device according to the invention with securing cap 20 and inserted heat transfer medium line 30. It is apparent from the enlarged representation that the notch 18 on the underside of the carrier element 10 only extends into the material to such an extent that a minimum material thickness 19 remains which ensures the strength and stability of the carrier element 10. An indentation 17 is provided on the upper side of the carrier element 10 between the side parts of the retaining element 12, the shape of which indentation approximates to the outer contour of the heat transfer medium line 30 to be accommodated. In this example, a corresponding indentation 21 is also provided in the securing cap 20. The indentations enhance retention of the heat transfer medium line 30 in the retaining element 12. The collars 14 of the side parts and the recesses 22 of the securing cap 20 are of triangular construction as in the left-hand part of FIG. 1. Observed in longitudinal section, the external contour of the securing cap 20 is trapezoidal.

The horizontal distance between the inner surfaces of the side parts of a retaining element 12 is preferably selected such that it corresponds to the external diameter of the heat transfer medium line 30 to be inserted. The distance preferably amounts to from 95% to 105%, particularly preferably from 98% to 100% of the external diameter of the heat transfer medium line 30. Conventional dimensions for corresponding external diameters are stated by way of example in the above table. The vertical distance between the upper side of the carrier element 10 and the inner side of securing cap 20 likewise preferably amounts to from 95% to 105%, particularly preferably from 98% to 100% of the external diameter of the heat transfer medium line 30. Optionally present indentations 17, 21 are taken into account when determining this distance.

If the horizontal and/or vertical distance is selected to be smaller than the external diameter of the heat transfer medium line 30, this results, when the securing cap 20 is pushed on, in a slight deformation of the heat transfer medium line 30. In this case, the securing cap 20 must be pushed onto the collars 14 of the side parts of the retaining element 12 under a certain amount of pressure. The dimensions are preferably selected such that the pressure to be applied is sufficient to ensure a tight fit of the securing cap 20 and thus to prevent the securing cap 20 from slipping out after being set in place on the collars. Alternatively or complementarily, the recesses 22 in the securing cap 20 may be dimensioned such that they are slightly smaller than the outer contour of the collar 14. In this case, a tight fit of the securing cap 20 on the collar 14 is ensured independently of the dimension of the inserted heat transfer medium line 30.

FIG. 5 shows a longitudinal section through an alternative embodiment of the fastening device according to the invention with inwardly directed collars 14. In the example, the collars 14 are triangular in shape in longitudinal section, the end face of the side parts dropping away obliquely inwards starting from the outer surface. The lowest point of the oblique end face is also the point which projects the furthest beyond the inner surface of the respective side part into the interior of the retaining element 12. In this embodiment, no securing cap is necessary. Retention of the heat transfer medium line 30 in the retaining element 12 is ensured in that, once the heat transfer medium line 30 has been pressed into the interior of the retaining element 12, the inwardly pointing collars 14 extend over the external contour of the heat transfer medium line and so prevent the latter from slipping out of the fastening device. As in the example of FIG. 4, an indentation 17 on the upper side of the carrier element 10 may also be provided in this embodiment, the shape of which indentation approximates to the outer contour of the heat transfer medium line to be accommodated.

FIGS. 6 and 7 show examples of containers which are equipped with fastening devices according to the invention and heat transfer medium lines. FIG. 6 shows the upper part of an upright container 40. A plurality of fastening devices according to the invention of various lengths are arranged in a vertical direction on the container. They are held in place by straps 50 which are tensioned around the circumference of the container 40 perpendicularly to the longitudinal orientation of the fastening devices. For clarity's sake, only a few straps are shown. Securing caps, which are pushed onto the collars of the retaining elements and fix the heat transfer medium lines, are symbolically indicated by black dots.

As soon as the fastening devices have been mounted on the container 40, a heat transfer medium line may straightforwardly be fitted onto the container. A first heat transfer medium line, which comprises an inlet 34a and an outlet 36a for the heat transfer medium, is shown by way of example in the upper zone of the container 40. It is wound in a spiral around the container, extending horizontally across the front of the container which is shown and obliquely downwards across the back, as indicated by the dashed lines. The downwardly inclined course of the heat transfer medium line on the back may straightforwardly be achieved by mounting adjacent fastening devices in each case a bit lower in accordance with the inclination. The fastening devices may optionally also be mounted slightly obliquely, so that the heat transfer medium line extends perpendicularly to the longitudinal axis of the carrier elements.

Below the first heat transfer medium line is mounted a second heat transfer medium line with an inlet 34b and an outlet 36b for the heat transfer medium. Due to a port 42, for example a manhole, located on the container, it is not possible at this point to lay the heat transfer medium line around the entire circumference of the container. In this case, it is appropriate to lay the heat transfer medium line in loops, the lines repeatedly being bent by 180°.

FIG. 7 shows an example of a horizontal container 40 which is provided with fastening devices according to the invention and heat transfer medium lines. Unlike in the example according to FIG. 6, in this case the majority of the straps 50 extend parallel to the fastening devices. Fastening devices with protrusions, as were described further above, are used here. The straps 50 extend over the protrusions and so retain the fastening devices against the outer wall of the container 40. Notches on the underside of the carrier elements furthermore have an advantageous effect in this example, as the fastening devices are mounted along the curvature of the container 40. In zones in which it is not appropriate to lay the straps parallel, for example in the zone above the port 42, the straps 50 are guided, as in the upright container according to FIG. 6, substantially perpendicularly to the longitudinal axis of the fastening devices. A first heat transfer medium line with an inlet 34a and an outlet 36a for the heat transfer medium is mounted in a spiral in the upper zone of the container 40. A second heat transfer medium line with an inlet 34b and an outlet 36b is provided in loop form to the left of the port.

The fastening devices according to the invention may advantageously be used to fasten heat transfer medium lines to containers. The entire container or also just zones of the container may here be provided with lines. The heat transfer medium lines may be used, for example, as heat tracing, in particular for reactors or columns in process engineering installations. Various heat transfer media may be used for this purpose, for example hot liquids or vapor such as water or steam at various pressures levels. In contrast with known electrical heating systems, the heat transfer medium may, however, also be used for cooling, for example by passing a cold fluid such as water through the heat transfer medium lines.

1. A fastening device for heat transfer medium lines comprising a strip-shaped carrier element (10) and a plurality of claw-shaped retaining elements (12) which in each case comprise two side parts, one end of which is firmly joined to the upper side of the carrier element (10), it being possible to place a heat transfer medium line (30) between the in each case two side parts of a retaining element (12), and the side parts of the retaining elements (12) also comprise a collar (14) at their end remote from the carrier element (10) and, with regard to their transverse orientation, are arranged substantially perpendicularly to the longitudinal direction of the carrier element (10), wherein the carrier element (10) and the holding elements (12) are manufactured from a polyamide material containing
A) 10 to 99.999 wt. % of a polyamide,
B) 0.001 to 20 wt. % of iron powder, which is obtainable by thermal decomposition of iron pentacarbonyl, and
C) 0 to 70 wt. % of further additives,
the sum of the weight percentages of components A) to C) amounting to 100%.

2. The fastening device according to claim 1, wherein the iron powder has a particle size of at most 10 μm (d₅₀ value).

3. The fastening device according to claim 1 or 2, wherein the collars (14) of the side parts of a retaining element (12) are located on the mutually facing inner sides of the side parts and are dimensioned such that the heat transfer medium line (30) may be snap-fitted from outside through the gap between the two respective collars (14) towards the carrier element (10) into the interior of the retaining element (12).

4. The fastening device according to claim 1 or 2, wherein the collars (14) of the side parts of a retaining element (12) extend away outwards from outer sides of the side parts, and the fastening device furthermore comprises securing caps (20) with recesses (22), wherein the collars (14) and recesses (22) are shaped complementarily to one another, such that the securing caps (20) may be placed over the collars (14), and, once a securing cap has been set in place over the collars of a retaining element (12), the heat transfer medium line (30) is fixed in the retaining element in question.

5. The fastening device according to one of claims 1 to 4, wherein the carrier element (10) comprises notches (18) on its underside between adjacent retaining elements (12).

6. The fastening device according to claim 5, wherein the minimum material thickness of the carrier element (10) between its upper side and the lowest point of the notch (18) amounts to from 1 mm to 2 mm.

7. The fastening device according to one of claims 1 to 6, wherein the carrier element (10) comprises lateral protrusions (16), the extent of which perpendicular to the longitudinal edge of the carrier element (10) amounts to from 1 cm to 4 cm, in particular from 2 cm to 3 cm, and the extent of which in the direction of the longitudinal edge of the carrier element (10) amounts to from 1 cm to 4 cm, in particular from 2 cm to 3 cm.

8. The fastening device according to one of claims 1 to 7, wherein the material thickness of the carrier element (10) amounts to from 4 mm to 12 mm, in particular from 5 mm to 7 mm, and the width of the carrier element (10) without taking account of optionally present protrusions (16) amounts to from 1.5 cm to 4 cm, in particular from 2 cm to 3 cm.

9. The fastening device according to one of claims 1 to 8, wherein the distance between the inner surfaces of the side parts of a retaining element (12) corresponds to from 95% to 105%, in particular from 98% to 100% of the external diameter of the heat transfer medium line (30).

10. The fastening device according to one of claims 4 to 9, wherein the height of the retaining elements (12) is selected such that, once the securing caps (20) have been set in place, the distance between upper side of the carrier element (10) and the inner side of the securing cap (20) corresponds to from 95% to 105%, in particular from 98% to 100% of the external diameter of the heat transfer medium line (30).

11. The fastening device according to one of claims 1 to 10, wherein the distance between the inner surfaces of the mutually facing side parts of two adjacent retaining elements (12) corresponds to twice the minimum bending radius (32) of a tubular heat transfer medium line (30) to be accommodated.

12. The fastening device according to one of claims 1 to 11, wherein the carrier element (10), the retaining elements (12) and optionally present protrusions (16) are based on the same material and are integrally joined to one another.

13. The fastening device according to one of claims 4 to 12, wherein the securing caps (20) are manufactured from a thermoplastic plastics material, in particular from a material based on polyamide, polysulfone, polyethersulfone or polyphenylenesulfone.

14. The fastening device according to one of claims 1 to 13, wherein the carrier element (10) has, on its underside, fastening means, especially permanent magnets or an adhesive coating, which are suitable for fastening the fastening device to a container without auxiliary means.

15. The use of a fastening device for fastening heat transfer medium lines (30) as heat tracing or cooling for a container, in particular a reactor or a column, wherein the fastening device comprises a strip-shaped carrier element (10) and a plurality of claw-shaped retaining elements (12) which in each case comprise two side parts, one end of which is firmly joined to the upper side of the carrier element (10), it being possible to place a heat transfer medium line (30) between the in each case two side parts of a retaining element (12), and the side parts of the retaining elements (12) also comprise a collar (14) at their end remote from the carrier element (10) and, with regard to their transverse orientation, are arranged substantially perpendicularly to the longitudinal direction of the carrier element (10).

16. The use according to claim 15, wherein the heat transfer medium lines (30) comprise corrugated hoses through which a liquid or gaseous heat transfer medium, in particular hot water or steam, is passed as the heat transfer medium.
